(19) United States
(12) Patent Application Publication
(10) Pub. No.: US 2007/0294086 A1
(43) Pub. Date: Dec. 20, 2007

(54) Speech recognition apparatus and navigation system

(75) Inventors: Ryuichi Suzuki, Okazaki-city (JP); Takafumi Hitotsumatsu, Anjo-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/724,168

(22) Filed: Mar. 15, 2007

(30) Foreign Application Priority Data
Mar. 23, 2006 (JP) 2006-81090

(51) Int. Cl. G10L 15/00

(52) U.S. Cl. 704/254; 704/E15.001

(57) ABSTRACT

Both a telephone number dictionary and a number dictionary are used for speech recognition of telephone numbers. The telephone number dictionary stores actually existent telephone numbers for fixed-line phones. The number dictionary stores variable numbers and digits. The telephone number dictionary ensures a relatively high recognition rate. When only the telephone number dictionary is used, the speech recognition dictionary needs to be updated each time a toll number or a local office number is changed. When it is necessary to recognize a mobile phone number that is frequently added or changed, the speech recognition dictionary also needs to be updated frequently. Such update work is very bothersome. However, the number dictionary can be used for speech recognition. The update work becomes unnecessary.

### CROSS REFERENCE TO RELATED APPLICATION

This application is based on and incorporates herein by reference Japanese Patent Application No. 2006-81090 filed on Mar. 23, 2006.

### FIELD OF THE INVENTION

The present invention relates to a speech recognition technology effectively used for speech input of telephone numbers or destinations in a navigation system, for example.

### BACKGROUND OF THE INVENTION

There is already commercialized a speech recognition apparatus that compares input speech with multiple prestored comparison patterns (recognition dictionary) and outputs a highly coincident pattern as a recognition result. Using such apparatus, for example, a user can speech-input a place or facility name to be specified for a navigation system. The apparatus is also used to speech-input telephone numbers in a handsfree system (see patent document 1). The speech recognition apparatus is especially effective when a driver uses an on-board system. The speech input requires no button operations or a watch on a screen. The speech recognition apparatus can ensure high-safety operations while a vehicle is moving.

The technique disclosed in patent document 1 sequentially changes input modes such as a toll number, a local office number, and a subscriber number. The technique accordingly changes speech recognition dictionaries to perform the speech recognition. While changing the dictionary corresponding to the mode improves the recognition accuracy, all the modes cannot be recognized at a time. The convenience is degraded.

Patent Document 1: JP-H11-46238 A

To improve the convenience, there is a need for recognizing a speech-input telephone number at a time. For this purpose, a speech recognition dictionary may include one of two types of dictionaries, i.e., a special telephone number dictionary (having existing fixed numbers) and a general number dictionary (only having variable numbers). However, the existing fixed numbers of the special telephone number dictionary may need to be updated appropriately; the greater number of recognition patterns held by the general number dictionary may degrade recognition performance, in recognition accuracy or time.

### SUMMARY OF THE INVENTION

The present invention has been made in consideration of the foregoing. It is therefore an object of the present invention to provide a speech recognition technology capable of restraining recognition performance from degrading without updating a speech recognition dictionary.

According to an aspect of the present invention, a speech recognition apparatus is provided as follows. A speech input unit is capable of inputting a speech. A dictionary unit is configured to store a plurality of comparison patterns. A recognition unit is configured to compare a speech input via the speech input unit with comparison patterns stored in the dictionary unit to provide a highly coincident pattern as a recognition result. The dictionary unit includes (i) a special dictionary constructed to be capable of recognizing a comparison pattern actually existent as a recognition object and (ii) a general dictionary constructed to be capable of recognizing comparison patterns possibly existent as a recognition object. The recognition unit provides a recognition result using both the special dictionary and the general dictionary.

According to another aspect of the present invention, a speech recognition apparatus is provided as follows. A speech input unit is capable of inputting a speech. A dictionary unit is configured to store a plurality of comparison patterns. A recognition unit is configured to compare a speech input by the speech input unit with comparison patterns stored in the dictionary unit and to provide a highly coincident pattern as a recognition result. An acceptance unit is capable of accepting an instruction from a user. A dictionary control unit is configured to specify one of the special dictionary and the general dictionary as a dictionary used for recognition based on an instruction accepted via the acceptance unit. The dictionary unit includes (i) a special dictionary constructed to be capable of recognizing a comparison pattern actually existent as a recognition object and (ii) a general dictionary constructed to be capable of recognizing comparison patterns possibly existent as a recognition object. The recognition unit provides a recognition result using one of the special dictionary and the general dictionary whichever is specified by the dictionary control unit.

According to yet another aspect of the present invention, a speech recognition apparatus is provided as follows. A dictionary unit has (i) a special dictionary for recognizing a comparison pattern actually existent as a recognition object and (ii) a general dictionary for recognizing comparison patterns possibly existent as a recognition object. An acceptance unit is capable of accepting an instruction from a user. A recognition unit is configured to compare a speech input with comparison patterns stored in the dictionary unit and to provide a highly coincident pattern as a recognition result. Dictionary determining means is configured to determine how to use the dictionary unit for recognition from among a first method and a second method. The first method specifies one of the special dictionary and the general dictionary as a dictionary used for recognition based on an instruction accepted via the acceptance unit. The second method differently weights the special dictionary and the general dictionary for the recognition unit to determine coincidence between a speech input and a comparison pattern. Here, the special dictionary is more heavily weighted than the general dictionary.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram schematically showing a construction of a navigation system having a speech recognition function;

FIG. 2 is a block diagram showing a construction of a speech recognition unit and a dialog control unit in a speech recognition apparatus;

FIGS. 3A, 3B diagramatically show dictionary data of a dictionary unit;

FIG. 4 is a flowchart showing a speech recognition process using both a telephone number dictionary and a number dictionary;

FIG. 5 is a flowchart showing a speech recognition process using one of the telephone number dictionary and the number dictionary; and

FIGS. 6A, 6B show another embodiment of dictionary data.

### DETAILED DESCRIPTION OF THE PREFERRED EMBODIMENTS

Embodiments of the present invention will be described in further detail with reference to the accompanying drawings. The invention is not limited to the embodiments described below but may be otherwise variously embodied within the technological scope of the invention.

<Description of the Construction>

(Description of an Overall Navigation System)

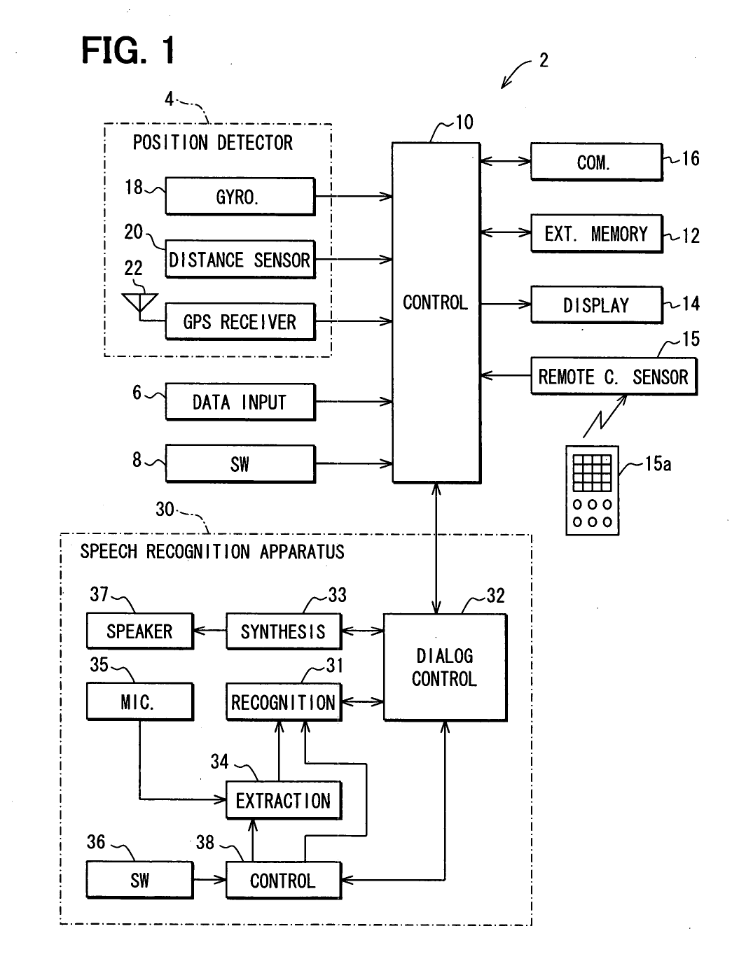

FIG. 1 is a block diagram schematically showing a construction of a navigation system 2 having a speech recognition function. The navigation system 2 is a so-called car navigation system mounted on a vehicle. The navigation system 2 includes a position detector 4, a data input device 6, an operation switch group 8, a control circuit 10 connected to these, external memory 12 connected to the control circuit 10, a display apparatus 14, a remote control sensor 15, a communication apparatus 16, and a speech recognition apparatus 30. The control circuit 10 is constructed as an ordinary computer. The control circuit 10 contains a known CPU, ROM, RAM, I/O, and a bus line connecting these components with each other.

The position detector 4 includes a known gyroscope 18, a distance sensor 20, and a GPS receiver 22 for detecting a vehicle position based on a radio wave from a satellite. These components 18, 20, and 22 have characteristically different errors and are therefore constructed to complement them with each other. Depending on accuracies, the position detector 4 may include part of the above-mentioned components. Further, it may be preferable to use a steering wheel sensor, a rolling wheel sensor, and the like.

The data input device 6 is used to enter various data including so-called map matching data for improving position detection accuracy, map data, and mark data. The data input device 6 is also used to enter dictionary data for recognition on the speech recognition apparatus 30. Generally, a hard disk or a DVD is used as a storage medium in consideration for the amount of data. In addition, a CD-ROM or the other media may be used. When a DVD is used as a data storage medium, the data input device 6 is equivalent to a DVD player.

The display apparatus 14 is capable of color display. The display apparatus 14 can superimpose a current vehicle position mark, map data, and additional data on the screen. The current vehicle position mark is input from the position detector 4. The map data is input from the map data input device 6. The additional data includes marks for a guide route and a predetermined point to be displayed on the map. The display apparatus 14 can also display a menu screen that presents multiple options. When an option is selected, the display apparatus 14 can display a command input screen that presents further options.

The communication apparatus 16 communicates with a destination specified by predetermined destination communication information. For example, the communication apparatus 16 is equivalent to a mobile communication device such as a mobile phone.

The navigation system 2 is provided with a so-called route guidance function. The function automatically selects an optimum route from the current position to a destination, and generates and displays a guide route. A destination position can be input from the remote control sensor 15 using a remote control terminal (hereafter referred to as a remote controller) 15a or from the operation switch group 8. The Dijkstra algorithm is a well-known technique of automatically settling an optimum route. The operation switch group 8 includes a touch switch or a mechanical switch integrated with the display apparatus 14 and is used for entering various commands.

The speech recognition apparatus 30 enables a user to speech-input various commands without manually using the operation switch group 8 or the remote controller 15a.

(Description of the Speech Recognition Apparatus 30)

The speech recognition apparatus 30 includes a speech recognition unit 31, a dialog control unit 32, a speech synthesis unit 33, a speech extraction unit 34, a microphone 35, a switch 36, a speaker 37, and a control unit 38.

The speech recognition unit 31 recognizes speech data supplied from the speech extraction unit 34 according to an instruction from the dialog control unit 32. The speech recognition unit 31 returns a recognition result to the dialog control unit 32. That is, the speech recognition unit 31 collates the speech data acquired from the speech extraction unit 34 with prestored dictionary data. The speech recognition unit 31 compares multiple comparison pattern candidates with each other and outputs highly coincident comparison patterns to the dialog control unit 32.

When a word sequence in the input speech is recognized, speech data supplied from the speech extraction unit 34 is acoustically analyzed against an acoustic model in sequence to extract an acoustic feature quantity (e.g., cepstrum). The acoustical analysis generates chronological data for the acoustic feature quantity. The chronological data is divided into portions based on a known HMM (Hidden Markov Model), a DP matching method, or a neural network. The recognition finds correspondence between each portion and a word stored as dictionary data.

The dialog control unit 32 allows the speech synthesis unit 33 to output a speech response based on the recognition result from the speech recognition unit 31 or an instruction from the control unit 38. Alternatively, the dialog control unit 32 notifies, for example, a destination or a command needed for the navigation to the control circuit 10 that performs processes for the navigation system itself. In this manner, the dialog control unit 32 settles the destination or executes the command. As a result of such process, the speech recognition apparatus 30 enables the speech input to specify a destination for the navigation system without manually operating the operation switch group 8 or the remote controller 15a.

The speech synthesis unit 33 uses a speech waveform stored in a waveform database to synthesize a speech based on the output instruction from the dialog control unit 32. The speaker 37 generates the synthesized speech.

When the microphone 35 collects an ambient speech, the speech extraction unit 34 converts the speech into digital data and supplies it to the speech recognition unit 31. To analyze the feature quantity of the input speech, the speech extraction unit 34 periodically extracts a frame signal on the order of several tens of milliseconds, for example. The speech extraction unit 34 determines whether or not the input signal corresponds to a speech section containing a speech or to a noise section not containing the same. The determination between the speech section and the noise section is needed because a signal input from the microphone contains not only a speech to be recognized, but also a noise. Conventionally, many techniques are proposed for the determination method. For example, a typical technique periodically extracts a short-term power of the input signal. The technique determines the speech section or the noise section according to whether or not the short-term power greater than or equal to a specified threshold continues for a specified period or longer. When the speech section is determined, the input signal is output to the speech recognition unit 31.

According to the embodiment, a user presses the switch 36 to input a speech via the microphone 35. Specifically, the control unit 38 monitors a timing to press or release the switch 36 or a time period to keep pressing the switch 36. When the switch 36 is pressed, the control unit 38 allows the speech extraction unit 34 and the speech recognition unit 31 to perform a process. When the switch 36 is not pressed, the control unit 38 disables the process from being performed. While the switch 36 is pressed, speech data supplied via the microphone 35 is output to the speech recognition unit 31.

Since the navigation system 2 according to the embodiment has the above-mentioned construction, a user can enter commands to perform various processes such as route setting, route guidance, facility retrieval, and facility display.

(Description of the Speech Recognition Unit 31 and the Dialog Control Unit 32)

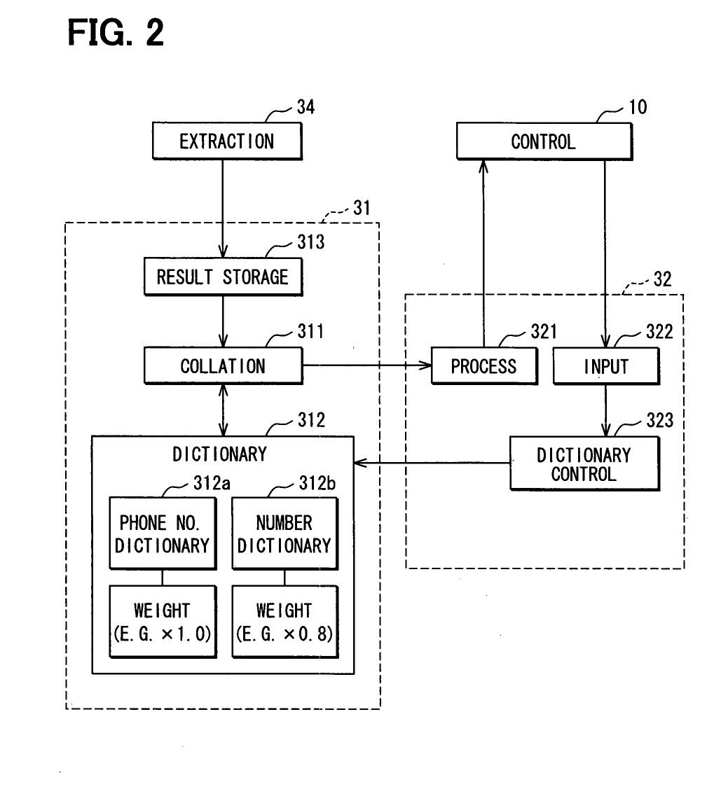

The speech recognition unit 31 and the dialog control unit 32 will be described in more detail. As shown in FIG. 2, the speech recognition unit 31 includes a collation unit 311, a dictionary unit 312, and an extraction result storage unit 313. The dialog control unit 32 includes a process unit 321, an input unit 322, and a dictionary control unit 323.

In the speech recognition unit 31, the extraction result storage unit 313 stores an extraction result output from the speech extraction unit 34. The collation unit 311 collates the stored extraction result with dictionary data stored in the dictionary unit 312. After comparison with the dictionary data, the collation unit 311 outputs recognition results with a high degree of coincidence (likelihood) to the process unit 321 of the dialog control unit 32. The process unit 321 outputs the recognition results to the control circuit 10.

The control circuit 10 provides the dialog control unit 32 with an instruction about a dictionary to be used or a weight. The control circuit 10 accepts a user operation via the operation switch group 8 and outputs an instruction based on the operation to the dialog control unit 32. The input unit 322 of the dialog control unit 32 accepts that instruction. Based on the instruction, the dictionary control unit 323 specifies the dictionary data or the weight for the dictionary unit 312 of the speech recognition unit 31.

The following describes the dictionary unit 312 and the dictionary data. The dictionary unit 312 includes a telephone number dictionary 312a and a number dictionary 312b for recognizing a telephone number that is speech-input from a user. The other dictionaries are used for speech recognition of the other words than telephone numbers, but are omitted here.

The dictionary control unit 323 of the dialog control unit 32 can be configured to use both or only one of the telephone number dictionary 312a and the number dictionary 312b as a dictionary for recognizing telephone numbers. The dictionary unit 312 can weight the telephone number dictionary 312a and the number dictionary 312b. The dictionary control unit 323 of the dialog control unit 32 can also configure weight values.

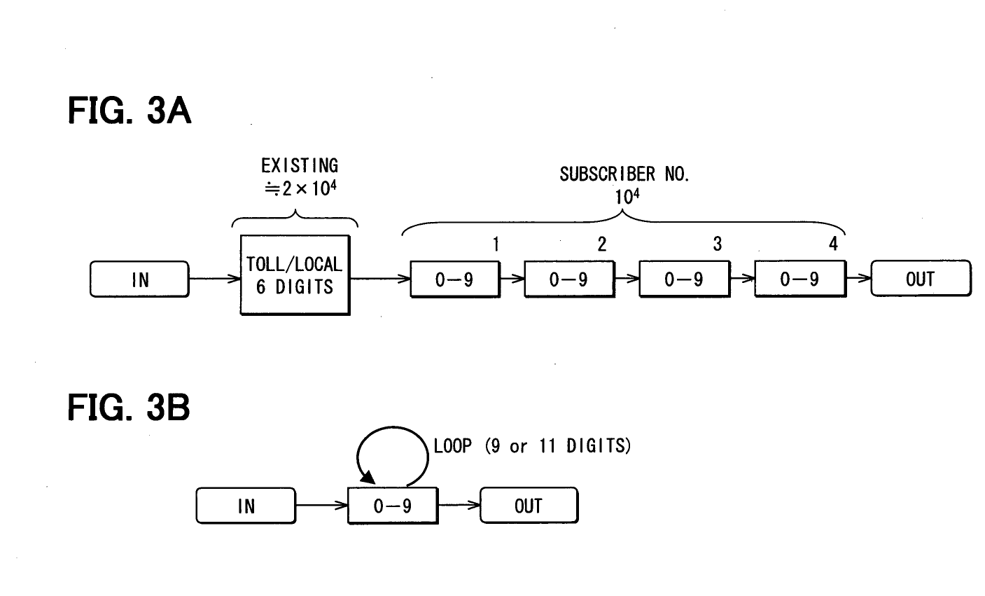

As shown in FIG. 3A, the telephone number dictionary 312a stores actually existent telephone numbers for fixed-line phones. The telephone number dictionary 312a is configured as a recognition dictionary that stores only existing toll numbers and local office numbers for six digits. The number of stored words approximates to 2×(10 raised to the fourth), i.e., 2×10⁴. Further, the telephone number dictionary 312a is configured as a variable-number recognition dictionary for 4-digit subscriber numbers. The number of stored words equals to 10 raised to the fourth, i.e., 10⁴. Consequently, the telephone number dictionary 312a stores the number of words equivalent to 2×(10 raised to the eighth), i.e., 2×10⁸, in total. Thus, the telephone number dictionary 312a is a special dictionary, which is constructed to be capable of recognizing a comparison pattern actually existent as a recognition object.

As shown in FIG. 3B, the number dictionary 312b is a variable-number and variable-digit recognition dictionary. The dictionary is constructed by combining the maximum number of (necessary) digits of numbers 0 through 9 to be recognized. The dictionary is capable of outputting a recognition result according to any number of digits. The number dictionary 312b can be used to recognize up to 11 digits of numbers so as to be able to recognize not only fixed-line phones, but also mobile phones. Specifically, the number dictionary 312b stores the number of words equal to ten raised to the 11th, i.e., 10¹¹. Thus, the number dictionary 312b is a general dictionary, which is constructed to be capable of recognizing comparison patterns possibly existent as a recognition object.

There has been described the overall construction of the navigation system 2. The microphone 35 according to the embodiment is equivalent to a speech input means or unit. The dictionary unit 312 in the speech recognition unit 31 is equivalent to a dictionary means or unit. In the dictionary unit 312, the telephone number dictionary 312a is equivalent to a special dictionary, and the number dictionary 312b is equivalent to a general dictionary. The collation unit 311 is equivalent to recognition means or unit. The operation switch group 8 and the microphone 35 are equivalent to a reception means or unit. The dictionary control unit 323 in the dialog control unit 32 is equivalent to a dictionary control means or unit. The speech synthesis unit 33, the speaker 37, and the display apparatus 14 are equivalent to a notification means or unit. The process unit 321 in the dialog control unit 32 is equivalent to a post-settlement processing means or unit.

(Description of a Speech Recognition Process)

With reference to flowcharts, the following describes speech recognition processes when a telephone number is speech-input to the navigation system 2 having the speech recognition function.

Two types of speech recognition processes will be described below.

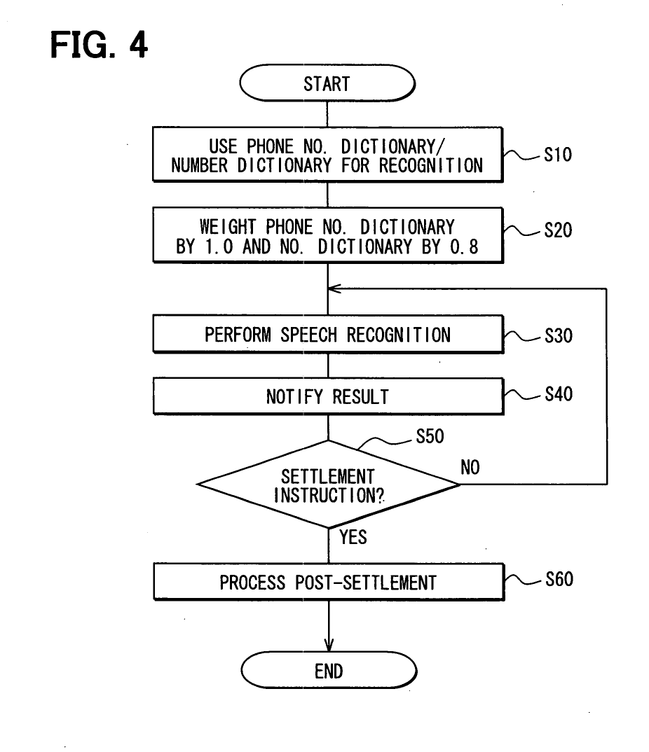

(1) First, with reference to a flowchart in FIG. 4, the following describes a process using both the telephone number dictionary 312a and the number dictionary 312b.

The flowchart in FIG. 4 shows a process performed by the speech recognition unit 31 and the dialog control unit 32 when the display apparatus 14 displays a telephone number input screen.

The telephone number input screen is used to enter a telephone number for simply placing a call or using the navigation function to specify a destination or retrieve a facility based on the entered telephone number, for example.

At Step S10, the dictionary control unit 323 enables both the telephone number dictionary 312a and the number dictionary 312b as dictionaries used by the collation unit 311 for telephone number recognition. At Step S20, the dictionary control unit 323 weights the telephone number dictionary 312a by 1.0 and the number dictionary 312b by 0.8.

At Step S30, the speech recognition process is performed. As mentioned above, the speech extraction unit 34 extracts speech data supplied via the microphone 35 while the switch 36 is pressed. The extracted speech data is output to the speech recognition unit 31. The recognition process is performed on this extraction result. Specifically, the extraction result storage unit 313 stores the extraction result output from the speech extraction unit 34. The collation unit 311 collates the stored extraction result with dictionary data stored in the dictionary unit 312. The collation uses both the telephone number dictionary 312a and the number dictionary 312b. The collation unit 311 weights the degrees of coincidence (likelihood) as the collation result. The collation unit 311 weights by 1.0 the degree of coincidence resulting from the telephone number dictionary 312a. The collation unit 311 weights by 0.8 the degree of coincidence resulting from the number dictionary 312b. The collation unit 311 finally outputs highly coincident candidates to the process unit 321.

At Step S40, the recognition result is notified. The process unit 321 may allow the speech synthesis unit 33 and the speaker 37 to audibly notify the result. Based on an instruction from the process unit 321, the control circuit 10 may allow the display apparatus 14 to display the result for notification.

At Step S50, it is determined whether or not a settlement instruction is available. The presence or absence of the settlement instruction is determined based on speech input from the microphone 35 by the user, for example. The presence of the settlement instruction can be determined when there is provided a speech input such as “yes” or “settle” that may be interpreted as a settlement instruction. The absence of the settlement instruction can be determined when there is provided a speech input such as “no” or “differ” that may not be interpreted as a settlement instruction. The user may issue the settlement instruction by means of not only speech input, but also switch operation. In this case, the presence or absence of the settlement instruction is determined according to whether or not the user operates the operation switch group 8 to settle the recognition result.

When there is no settlement instruction (NO at Step S50), the process returns to Step S30 for retrying the speech recognition based on speech input, and then proceeds to Steps S40 and S50.

When there is a settlement instruction (YES at Step S50), the process proceeds to a specified post-settlement process at Step S60. The post-settlement process not only allows the process unit 321 to output the recognition result to the control circuit 10, but also notifies settlement of the recognition result. The control circuit 10 functions as follows according to the post-settlement process. For example, the telephone number input screen may be used for the navigation function to specify a destination or retrieve a facility based on the entered telephone number. In this case, the control circuit 10 uses the settled telephone number to retrieve a destination or a facility. Alternatively, the telephone number input screen may be used to enter the telephone number simply for placing a call. In this case, the control circuit 10 allows the communication apparatus 16 to originate a call.

Both the telephone number dictionary 312a and the number dictionary 312b are used for the speech recognition of telephone numbers. When only the telephone number dictionary 312a is used, the speech recognition dictionary needs to be updated each time a toll number or a local office number is updated. When it is necessary to recognize a mobile phone number that is frequently added or changed, the speech recognition dictionary also needs to be updated frequently. Such update work is very bothersome. However, the speech recognition apparatus 30 in the navigation system 2 according to the invention eliminates the need for the update work. This is because the apparatus is capable of the speech recognition using the number dictionary 312b.

On the other hand, the use of only the number dictionary 312b relatively degrades a recognition rate for the speech recognition. When only the number dictionary 312b is used for the speech recognition, the recognition performance remarkably degrades compared to the special telephone number dictionary. The recognition rate is very important for the speech recognition. When the recognition rate is low, the user needs to repeat a speech input and feels inconvenience. The speech recognition apparatus 30 can prevent the recognition rate from degrading because the apparatus can use the telephone number dictionary 312a for the speech recognition.

The speech recognition apparatus 30 uses both the telephone number dictionary 312a and the number dictionary 312b for the speech recognition. Therefore, it is possible to prevent the recognition performance from degrading without updating the recognition dictionary.

The speech recognition apparatus 30 assigns different weights to the telephone number dictionary 312a and the number dictionary 312b used by the collation unit 311 for determining degrees of coincidence. Specifically, the telephone number dictionary 312a is weighted so as to take precedence over the number dictionary 312b. This is preferable because the telephone number dictionary 312a stores actually existing telephone numbers.

It is difficult to actually achieve a 100% recognition rate even though the use of the telephone number dictionary 312a improves the recognition rate for speech recognition. Countermeasures against incorrect recognition are desirable. The embodiment may audibly or visually notify the user of a recognition result, and then accept a specified settlement instruction from the user. In this case, the embodiment can assume the recognition result to be settled and perform a specified post-settlement process. When the recognition result differs from the contents the user uttered, he or she can retry the speech input.

As described with reference to the process at Step S20 in FIG. 4, the dictionary control unit 323 weights the telephone number dictionary 312a by 1.0 and the number dictionary 312b by 0.8. The weights may be user-specifiable. For example, a user's instruction may be accepted via the operation switch group 8. Based on the accepted instruction, the dictionary control unit 323 may configure the weight. As one example, weight 1.0 can be assigned to the telephone number dictionary 312a and the number dictionary 312b to equalize the weights for both. As another example, weight 1.0 is assigned to the telephone number dictionary 312a and weight 0.7 or 0.6 is assigned to the number dictionary 312b to increase a difference between the weights for both.

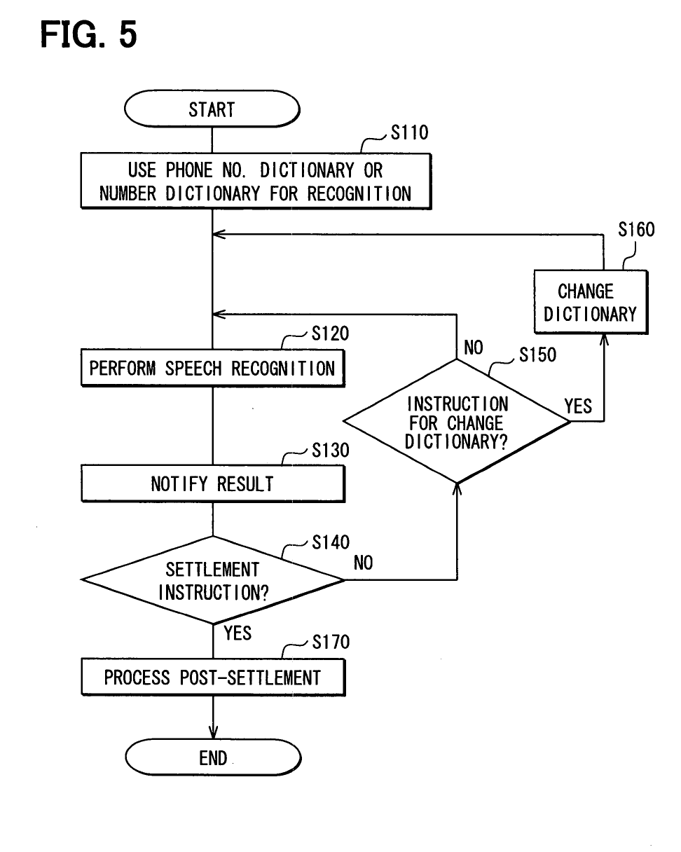

(2) Second, with reference to a flowchart in FIG. 5, the following describes a process using one of the telephone number dictionary 312a and the number dictionary 312b.

The flowchart in FIG. 5 shows a process performed by the speech recognition unit 31 and the dialog control unit 32 when the display apparatus 14 displays the telephone number input screen. The telephone number input screen is described above and is omitted here.

At Step S110, the dictionary control unit 323 enables a dictionary in the dictionary unit 312, i.e., one of the telephone number dictionary 312a and the number dictionary 312b. The selected dictionary is used by the collation unit 311 for telephone number recognition. Either dictionary may be automatically selected by default or may be selected based on a user instruction. In the latter case, for example, the display apparatus 14 may display a screen for prompting a user to select the telephone number dictionary 312a or the number dictionary 312b. The selected dictionary can be determined based on an operation via the operation switch group 8.

At Step S120, the speech recognition process is performed. According to the process in FIG. 4, the dictionary control unit 323 weights the telephone number dictionary 312a and the number dictionary 312b. On the other hand, the process in FIG. 5 includes no weighting because only one dictionary is used.

The speech extraction unit 34 extracts speech data supplied from the microphone 35 while the switch 36 is pressed. The extracted speech data is output to the speech recognition unit 31. The speech recognition process at Step S120 is performed on this extraction result. Specifically, the extraction result storage unit 313 stores an extraction result output from the speech extraction unit 34. The collation unit 311 collates the stored extraction result with dictionary data stored in the dictionary unit 312. The collation uses either the telephone number dictionary 312a or the number dictionary 312b.

At Step S130, the recognition result is notified. The process unit 321 may allow the speech synthesis unit 33 and the speaker 37 to audibly notify the result. Based on an instruction from the process unit 321, the control circuit 10 may allow the display apparatus 14 to display the result for notification.

At Step S140, it is determined whether or not a settlement instruction is available. The example is described at Step S50 in FIG. 4 and is therefore omitted.

When there is no settlement instruction (NO at Step S140), the process proceeds to Step S150 and determines whether or not there is an instruction for changing the dictionary. The presence or absence of the dictionary change instruction is determined based on the user's speech input from the microphone 35, for example. The presence of the dictionary change instruction can be determined when there is provided a speech input such as “dictionary changed” or “change the dictionary” that may be interpreted as a dictionary change instruction. The absence of the settlement instruction can be determined when there is provided a speech input such as “do not change the dictionary” or “leave the dictionary unchanged” that may not be interpreted as a dictionary change instruction. The user may issue the settlement instruction by means of not only speech input, but also switch operation. In this case, the presence or absence of the dictionary change instruction is determined according to whether or not the user operates the operation switch group 8 to change the dictionary.

When there is no dictionary change instruction (NO at Step S150), the process returns to Step S120 for retrying the speech recognition based on speech input, and then proceeds to Steps S130 and S140.

When there is a dictionary change instruction (YES at Step S150), the process selects the dictionary other than the currently active one in the dictionary unit 312 so as to be used by the collation unit 311 for the telephone number recognition. When the telephone number dictionary 312a is currently active, the number dictionary 312b is selected. When the number dictionary 312b is currently active, the telephone number dictionary 312a is selected. The process then returns to Step S120 for performing the speech recognition based on speech input, and then proceeds to Steps S130 and S140.

When the determination at Step S140 yields an affirmative result, i.e., when there is a settlement instruction, the process proceeds to Step S170 and performs the specified post-settlement process. The post-settlement process is described above with reference to Step S60 in FIG. 4 and is omitted here.

The speech recognition for telephone numbers first uses either the telephone number dictionary 312a or the number dictionary 312b. When the speech recognition fails using the one dictionary, the other dictionary is then used for the speech recognition. It is possible to prevent the speech recognition performance from degrading without updating the recognition dictionary.

The speech recognition apparatus 30 is capable of speech recognition only using the telephone number dictionary 312a. The number dictionary 312b is unnecessary when the user knows that the telephone number dictionary 312a stores a telephone number intended for speech input. Using only the telephone number dictionary 312a can more effectively prevents incorrect recognition. The number dictionary 312b contains more words than the telephone number dictionary 312a. When only the telephone number dictionary 312a is used, it is possible to recognize a smaller number of stored words and reduce processing loads.

For example, there may be a case where the user mistakenly believed that the special dictionary stores the intended telephone number, though actually not stored. In such case, the use of the telephone number dictionary 312a may cause an improper recognition result. Then, it is preferable to use the number dictionary 312b as a general dictionary for the speech recognition. The above-mentioned speech recognition process can provide such countermeasures.

<Effects>

In the above embodiment, the following disadvantages are relieved. As explained above in FIG. 3A, the special telephone number dictionary is constructed as a recognition dictionary that stores only actual toll numbers and local office numbers for six digits. The special telephone number dictionary is also constructed as a variable-number recognition dictionary for 4-digit subscriber numbers. The variable-number recognition dictionary provides combinations of 0 through 9.

Further, as explained above in FIG. 3B, the general number dictionary is a variable-number and variable-digit recognition dictionary. The dictionary is constructed by combining the maximum number of (necessary) digits of numbers 0 through 9 to be recognized. The dictionary is capable of outputting a recognition result according to any number of digits.

A recognition rate is very important for the speech recognition. When the recognition rate is low, a user needs to repeat a speech input and feels inconvenience. From this viewpoint, the special telephone number dictionary in FIG. 3A ensures a higher recognition rate than the general number dictionary in FIG. 3B.

When the specially customized telephone number dictionary is used, however, the speech recognition dictionary needs to be updated each time a toll number or a local office number is changed. When it is necessary to recognize a mobile phone number that is frequently added or changed, the speech recognition dictionary also needs to be updated frequently. Such update work is very bothersome, which may be called a first disadvantage.

It is preferable to use the general number dictionary from the viewpoint of preventing the bothersome update work. In this case, the speech recognition dictionary need not be updated. However, the general number dictionary remarkably degrades the recognition performance compared to the telephone number dictionary that stores only existing telephone numbers for recognition. The reason will be described by citing an example.

The speech recognition performance depends on the number of words stored in the recognition dictionary. The number of stored words is equivalent to the number of candidates that can be recognized. An actual recognition requires as many retrievals as the candidates, which may affect the recognition performance. Since a recognition result is selected from the candidates, increasing the number of candidates degrades the recognition performance.

The special telephone number dictionary in FIG. 3A as the recognition dictionary stores only existing toll numbers followed by local office numbers for six digits. On the other hand, the general number dictionary in FIG. 3B is not limited to the existing numbers and will contain an increasing number of stored words depending on the number of digits. For example, up to 11 digits of numbers need to be recognized in order to recognize not only fixed-line phones, but also mobile phones. In this case, the general number dictionary stores the number of words equal to ten raised to the 11th. The special telephone number dictionary in FIG. 3A stores only existing toll numbers and local office numbers for six digits. The number of stored words approximates to 2×(10 raised to the fourth). Since a 4-digit subscriber number is variable, the number of stored words equals to 10 raised to the fourth. Consequently, the special telephone number dictionary stores the number of words equivalent to 2×(10 raised to the eighth) in total. By comparison, the general number dictionary stores the number of words approximately 500 times more than the special telephone number dictionary in FIG. 3A. This signifies that the number of recognition candidates also increases 500 times. The recognition performance degrades remarkably, which may be called a second disadvantage.

To that end, the speech recognition apparatus according to the above embodiment of the present invention provides a technology to relieve the above-mentioned first and second disadvantages at the same time.

<Modification>

(1) The speech recognition according to the embodiment can be applied to the other numbers than the telephone numbers as mentioned above.

Numbers intended for the speech recognition include not only the above-mentioned telephone numbers, but also postal codes, map codes, and residential addresses, for example. These numbers may vary with the existing numbering system and the number of digits, both of which may be changed in the future. In such case, it only needs to use a postal code dictionary, a map code dictionary, and a residential address dictionary constructed based on the currently existing numbers instead of the telephone number dictionary 312a.

(2) The embodiment can be applied to recognition objects other than numbers in terms of such techniques as using the special dictionary and the general dictionary and varying weights. Another applicable technique is selectively using the special dictionary or the general dictionary and changing to the other dictionary for re-recognition when the currently active dictionary does not yield a satisfactory recognition result.

The embodiment can be applied to recognition of commands or place names, for example. In this case, the recognition dictionary may contain a special dictionary that stores only words used for each task. On the other hand, the recognition dictionary contains a general dictionary for monosyllabic recognition because all words need to be recognized. The monosyllabic recognition is used to recognize individual syllables such as “a,” “i,” and “u.” Similarly to the number recognition, looping this dictionary makes it possible to recognize any words as well as prestored words for recognition. The dictionary is constructed similarly to that shown in FIG. 3B and contains syllables “a” through “n” according to the Japanese syllabary in place of numbers 0 through 9.

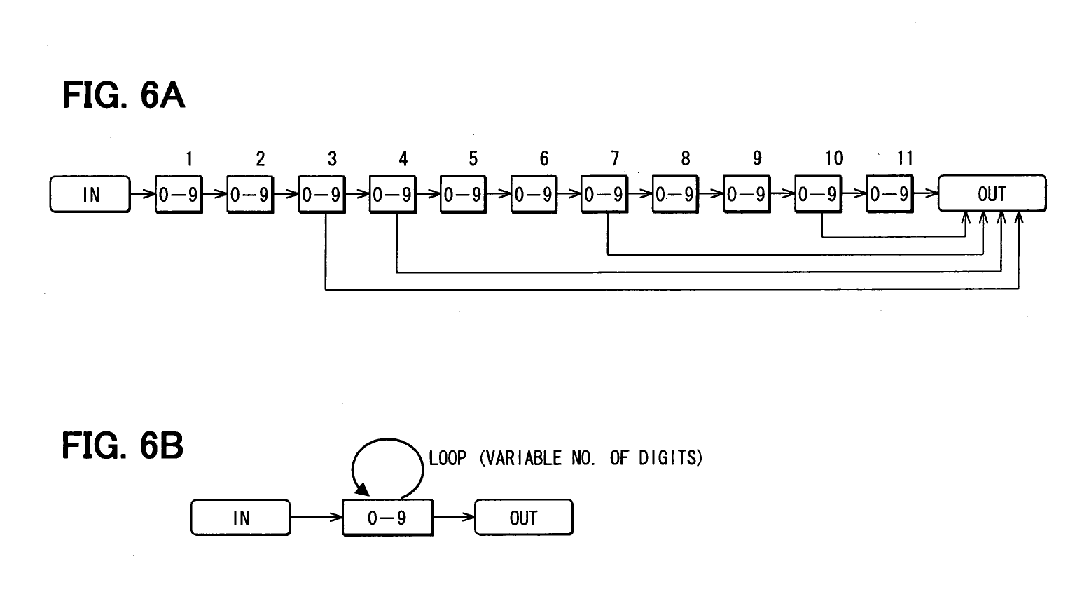

(3) FIGS. 6A, 6B show possible combinations of the special dictionary and the general dictionary in terms of the number recognition.

A dictionary in FIG. 6A contains the fixed number (eleven) of digits and variable numbers (zero to nine). A dictionary in FIG. 6B variable digits and numbers similarly to the dictionary in FIG. 3B.

When successive numbers are recognized in American English, for example, recognition experiments and empirical data based on speech collections demonstrate that numbers are often uttered in groups of 3, 4, 7, 10, or 11 digits. In consideration for this, it may be preferable to use a special dictionary that contains the fixed number of digits (recognizing only 3, 4, 7, 10, and 11 digits) and variable numbers (0 through 9).

Each or any combination of processes, steps, or means explained in the above can be achieved as a software unit (e.g., subroutine) and/or a hardware unit (e.g., circuit or integrated circuit), including or not including a function of a related device; furthermore, the hardware unit can be constructed inside of a microcomputer.

Furthermore, the software unit or any combinations of multiple software units can be included in a software program, which can be contained in a computer-readable storage media or can be downloaded and installed in a computer via a communications network.

It will be obvious to those skilled in the art that various changes may be made in the above-described embodiments of the present invention. However, the scope of the present invention should be determined by the following claims.

What is claimed is:

1. A speech recognition apparatus comprising:
a speech input unit capable of inputting a speech;
a dictionary unit configured to store a plurality of comparison patterns; and
a recognition unit configured to compare a speech input via the speech input unit with comparison patterns stored in the dictionary unit to provide a highly coincident pattern as a recognition result, wherein
the dictionary unit includes (i) a special dictionary constructed to be capable of recognizing a comparison pattern actually existent as a recognition object and (ii) a general dictionary constructed to be capable of recognizing comparison patterns possibly existent as a recognition object, and
the recognition unit provides a recognition result using both the special dictionary and the general dictionary.

2. The speech recognition apparatus of claim 1,
wherein the special dictionary and the general dictionary are differently weighted for the recognition unit to determine coincidence between a speech input and a comparison pattern, and the special dictionary is more heavily weighted than the general dictionary.

3. The speech recognition apparatus of claim 2, further comprising:
an acceptance unit capable of accepting an instruction from a user; and
a dictionary control unit configured to provide a weight to the special dictionary and the general dictionary based on an instruction accepted via the acceptance unit so as to determine coincidence by the recognition unit, wherein
the recognition unit determines the coincidence based on a weight provided by the dictionary control unit.

4. The speech recognition apparatus of claim 1, further comprising:
an acceptance unit capable of accepting an instruction from a user;
a notification unit configured to notify a recognition result provided by the recognition unit; and
a post-settlement processing unit configured to perform a specified post-settlement process, assuming a recognition result from the notification unit to be settled, on condition that the notification unit notifies the recognition result, and then a specified settlement instruction is accepted via the acceptance unit.

5. The speech recognition apparatus of claim 1,
wherein the dictionary unit includes the special dictionary and the general dictionary at least concerning numeric data.

6. A speech recognition apparatus comprising:
a speech input unit capable of inputting a speech;
a dictionary unit configured to store a plurality of comparison patterns;
a recognition unit configured to compare a speech input by the speech input unit with comparison patterns stored in the dictionary unit and to provide a highly coincident pattern as a recognition result;
an acceptance unit capable of accepting an instruction from a user; and
a dictionary control unit configured to specify one of the special dictionary and the general dictionary as a dictionary used for recognition based on an instruction accepted via the acceptance unit, wherein
the dictionary unit includes (i) a special dictionary constructed to be capable of recognizing a comparison pattern actually existent as a recognition object and (ii) a general dictionary constructed to be capable of recognizing comparison patterns possibly existent as a recognition object, and
the recognition unit provides a recognition result using one of the special dictionary and the general dictionary whichever is specified by the dictionary control unit.

7. The speech recognition apparatus of claim 6, further comprising:
a notification unit configured to notify a recognition result provided by the recognition unit; and
a post-settlement processing unit configured to perform a specified post-settlement process, assuming a recognition result from the notification unit to be settled, on condition that the notification unit notifies the recognition result, and then a specified settlement instruction is accepted via the acceptance unit,
wherein the dictionary control unit changes a most recently active dictionary to another dictionary to be used for recognition on condition that the notification unit notifies a recognition result, and then a dictionary change instruction is accepted via the acceptance unit.

8. The speech recognition apparatus of claim 6,
wherein the dictionary unit includes the special dictionary and the general dictionary at least concerning numeric data.

9. A navigation system comprising:
the speech recognition apparatus of claim 1; and
a navigation apparatus that performs a specified process based on a result recognized by the speech recognition apparatus, wherein
the speech input unit is used for a user to speech-input data that is associated with a place name and needs to be specified for navigation by the navigation apparatus.

10. A navigation system comprising:
the speech recognition apparatus of claim 6; and
a navigation apparatus that performs a specified process based on a result recognized by the speech recognition apparatus, wherein the speech input unit is used for a user to speech-input data that is associated with a place name and needs to be specified for navigation by the navigation apparatus.

11. A speech recognition apparatus comprising:
a dictionary unit having (i) a special dictionary for recognizing a comparison pattern actually existent as a recognition object and (ii) a general dictionary for recognizing comparison patterns possibly existent as a recognition object;
an acceptance unit capable of accepting an instruction from a user;
a recognition unit for comparing a speech input with comparison patterns stored in the dictionary unit and to provide a highly coincident pattern as a recognition result; and
dictionary determining means for determining how to use the dictionary unit for recognition from among a first method and a second method,
the first method specifying one of the special dictionary and the general dictionary as a dictionary used for recognition based on an instruction accepted via the acceptance unit,
the second method differently weighting the special dictionary and the general dictionary for the recognition unit to determine coincidence between a speech input and a comparison pattern, the special dictionary being more heavily weighted than the general dictionary.
